(19) United States
(12) Patent Application Publication
(10) Pub. No.: US 2026/0241347 A1
(43) Pub. Date: Aug. 20, 2026

(54) DEVICE FOR TRANSPORT AND TREATMENT OF LIQUID

(71) Applicant: SEARAS AS, Bergen (NO)

(72) Inventors: Morten AGA, Bergen (NO); Eldar LIEN, Bergen (NO)

(21) Appl. No.: 17/606,328

(22) PCT Filed: Apr. 29, 2020
(86) PCT No.: PCT/NO2020/050109

§ 371 Date: Oct. 25, 2021

(30) Foreign Application Priority Data
Apr. 29, 2019 (NO) 20190561
Jul. 10, 2019 (NO) 20190873

(51) Int. Cl. B01F 23/231; A01K 63/04; B01D 19/00; B01D 21/26; B01F 23/80; B01F 35/213; B01F 101/00; C02F 1/74; F04F 1/18

(52) U.S. Cl. CPC B01F 23/23121; B01D 19/0005; B01D 19/0036; B01D 19/0057; B01D 21/267; B01F 23/231265; B01F 23/803; B01F 35/213; C02F 1/74; F04F 1/18; A01K 63/042; B01F 2101/305; C02F 2209/22

(57) ABSTRACT

Device (10) for transporting a liquid from a first location to a second location characterized in that the device (10) comprises a conduit (16) for transporting the liquid from a first location to a second location, where the upper portion of the conduit (16) has the shape of an arch (30) establishing a space above the liquid surface, and wherein the conduit (16) comprises a first upstream conduit portion (16a) for receiving of liquid from said first location, and one or more outflow portions (16g) arranged in an upper portion of the conduit (16) in order to discharge liquid out of the conduit (16), and where there is arranged means (17) for supplying microbubbles in the upstream conduit portion (16a) to the conduit portion (16), where the length of upstream conduit portion (16a) and the position of the of outflow portion (16g) are arranged so that liquid is received in the conduit (16) from a first location at a certain depth in a volume of liquid and that liquid is expelled from the outflow conduit portion (16g) at a second location, that is vertically higher in the liquid volume than the first location.

### FIELD OF THE INVENTION

The present invention relates to a device for the transport of liquid and/or for the addition of gases to a liquid, and/or for the removal of gases and particles from a liquid. In particular, it is preferred to transport liquid from the desired depth and up to the surface in a net cage, as well as the addition of O₂.

### BACKGROUND OF THE INVENTION

In many systems, it is necessary to move fluid from one location to another. The system described in this application is first and foremost intended to be used in a fish farm net cage where large water exchange is needed. This can be, for example, in a net cage where lice skirts are used, i.e. where one has a watertight skirt on the outside of the net cage which prevents lice from entering the net cage, but which will also prevent water exchange from the net cage with the surrounding water. The solution will then bring large volumes of water from a desired depth to the surface of the net cage.

The system can also be used to move fluid in watertight net cages, either in that the water exchange inlet is located deep in the net cage, or it can be arranged underneath, on the outside of the net cage.

In many systems, there is also a need to remove gases and small particles from a liquid. This is the case, for example, in fish farming installations where the fish in the installation produce CO₂ and where feed residues and faeces from fish lead to the accumulation of organic material which is difficult to filter out through traditional mechanical filters. If the liquid is to be recycled back to the installation, as in so-called RAS plants, then CO₂ must be removed, and preferably be replaced with O₂, and that most of the small particles should be removed to give the fish a good environment. Small particles of organic matter nourish the heterotrophic bacteria that compete with the autotrophic bacteria in the biofilter. The best way to help the autotrophic bacteria is to limit organic matter which is the nutrient of the heterotrophic bacteria. Extraction of organic material also reduces the risk of H₂S in the installation. A good skimming will also remove bacteria and viruses from the water.

In order to vent the water for CO₂, it is important that air is injected in the form of microbubbles into the water. This gives a large contact surface between air and water, and thus the gas exchange becomes more efficient, while at the same time the underpressure will help to drive the gas out of the water and into the air.

Microbubbles are also the key to getting the smallest particles (<40 μm) bound to the bubbles such that they come with these up and out of the system.

Such removal of gases and small particles from a liquid can be combined with the actual movement of liquid from one location to another. The movement of fluid can be from one location within the net cage (typically deep in the net cage) to another location in the net cage (typically high in the net cage), or in the water surface. Often, the liquid is also moved from centrally in the net cage and is discharged in parts more peripherally in the net cage. One can also transfer fluid from the net cage (typically deep in the net cage) to a location outside the net cage, and one can retrieve liquid from a location outside the net cage (at a desired depth, typically deep) and into the net cage.

Water treatment is also needed in many other contexts, such as, for example, wastewater treatment.

### OBJECTS OF THE PRESENT INVENTION

It is an object of the present invention to provide a solution in which fluid can be moved from one location to another. Preferably, the object is to provide a solution in which fluid is moved from a location deep in the net cage to a location higher up in the net cage, or at the liquid surface. It is also an aim of the invention to add oxygen to the water. In this case either in the form of concentrated O₂, or by the addition of air.

In combination with the above object, it is also an object of the present invention to provide a solution in which gases and the smallest particles are removed and amongst other things lice larvae, algae and other parasites from a fluid. Preferably, it is an aim to provide a solution for removing organic particles, but it is intended that the solution be used to remove any gas and type of particle (e.g., microplastics) dissolved in a liquid.

It is also an object of the present invention to provide a solution in which smaller particles and foam are removed from a liquid.

It is also an object of the present invention to provide a solution in which oxygen is added to the water.

The solution produced is based in part on the principle of siphon and the establishment of an underpressure in a part of a pipeline, and in this way one can also transport a liquid from one container to another.

Thus, it is also an object of the present invention to provide a solution that can move a volume of liquid from one container to another, or from one location to another in the same container.

### SUMMARY OF THE INVENTION

The present invention relates to a device for the transport of liquid from a first location to a second location, characterised in that the device comprises a pipeline for transport of the liquid from a first location to a second location, where the upper part of the pipeline is in the form of a dome which establishes a space above the liquid surface, and the pipeline is comprised of a first upstream pipe part for intake of liquid from said first location, and one or more outstream parts arranged in an upper part of the pipeline for conveying liquid out of the pipeline, and where means are arranged in the upstream pipe part for supplying microbubbles to the pipe part (16a), where the length of the upstream pipe part and the position of the outstream pipe part (16g) are arranged so that liquid is taken up in a pipeline from a first location at a given depth in a liquid volume and that liquid flows from the outstream pipe part at a second location that is vertically higher in the liquid volume than the first location.

In one embodiment, the upper part of the pipeline is in the form of a dome.

In one embodiment, the dome is arranged such that the upper part of the dome is above the liquid surface, while the lower part of the dome and the outflow pipe part are below the liquid surface.

In one embodiment, said means for the supply of microbubbles is an ejector which is driven by supply of liquid, preferably high pressure water.

In one embodiment, gas or air may be supplied in an upper part of the dome.

In one embodiment, said gas is oxygen (O₂) which is supplied via a pipeline (40).

In one embodiment, oxygen (O₂) is supplied to the ejector, and that parts of said O₂ are brought via a pipeline (42) from the inside under the top of the dome.

In one embodiment, air can be supplied via a damper in the dome.

In one embodiment, the dome is equipped with one or more check valves.

In one embodiment, the outstream pipe part stretches into parts of, or in a 360 degree sector out from the upstream pipe parts.

In one embodiment, the means for supplying microbubbles are angled in different directions, set up so that the microbubbles are spread over the entire cross-section of the upstream pipe part.

In one embodiment, a funnel-shaped unit is arranged near the liquid surface of the dome set up to collect foam in the liquid surface and drain this foam through a pipeline (44), preferably horizontally or vertically down the centre pipe.

In one embodiment, the vault/dome is closed and that means are arranged to the dome to reduce the pressure in the dome.

In one embodiment, the device comprises a sensor for measuring the oxygen content of the water flowing out of the outflow pipe part.

In one embodiment, the supply of air is regulated and oxygen is regulated based on the oxygen level in the water as measured by the sensor.

In one embodiment, the outflow pipe part comprises an, in the main, horizontal pipe part, a downstream pipe part for passing liquid out of the pipeline, and a venting pipe part for passing gases, particles and a part of liquid out of the pipeline via the pipe part.

In one embodiment, liquid flows from the outflow pipe part or downstream pipe part close to, or just below, the liquid surface.

In one embodiment, two or more horizontal pipe parts are in fluid communication with an upstream pipe part.

In one embodiment, two or more horizontal pipe parts extend from the upstream pipe part in the same vertical region.

In one embodiment, said two or more horizontal pipe parts extend from the upstream pipe part (16a) at different vertical positions.

In one embodiment, a dome or a pipe part is connected to a cyclone.

In one embodiment, the device is comprised of a float or buoyancy means.

In one embodiment, said float or buoyancy means is a floating buoy with permanent buoyancy and a number of vertical air-filled tubes where water can be injected to fine-tune the depth.

In one embodiment, said float or buoyancy means are arranged around the upstream pipe part.

In one embodiment, the device is arranged in a net cage, where the net cage is comprised of a float collar that keeps the net cage afloat and that the device is anchored in the net cage float collar.

In one embodiment, the dome floats on the water surface and is loosely arranged over the upstream pipe part with flexible lines.

In one embodiment, a feed spreader is provided in an upper part of the device, preferably around the dome.

In one embodiment, the device is arranged inside a net cage, or outside a net cage.

In one embodiment, the device is used in a fish farming installation with lice skirts.

In one embodiment, the device is used in a watertight fish farming installation, preferably in a RAS plant.

In one embodiment, the device is arranged in the centre of a circular biofilter.

A solution is also described in FIG. 4 where underpressure is established.

In one embodiment, means are arranged in the upper part of the cyclone to generate an underpressure in the cyclone, venting pipe parts and dome.

In one embodiment, 0-25%, more preferably, 0.01-10% of the liquid passing through the pipeline is discharged via the venting pipe part.

In one embodiment, the upstream pipe part and/or the horizontal pipe part is comprised of a garland with openings, set up for passively sucking in of air to the fluid flow that is led through the horizontal pipeline section.

In one embodiment, said means for establishing an underpressure is a vacuum pump or a fan.

In one embodiment, the venting pipe parts or dome have a certain volume which ensures a large liquid: gas interface, and that the liquid circulates slowly via the pipeline.

In one embodiment, 0-25%, more preferably, 0.01-10% of the liquid passing through the pipeline is discharged via the venting pipe part.

### DESCRIPTION OF THE FIGURES

Preferred embodiments of the invention shall in the following be described in more detail with reference to the accompanying figures, in which:

FIG. 1 shows schematically a device for the transport of liquid from one location to another, and for the removal of gases and particles from the liquid transported from one location to another.

FIG. 2 shows schematically a device for the transport of liquid from one location to another, and for the removal of gases from a liquid, where gases, particles and liquid are further separated from the liquid in a cyclone.

FIG. 3 shows schematically an embodiment according to the invention for the transport of liquid from one location to another location, preferably from the depths of a net cage to the water surface of the net cage. Liquid is led to a dome which forms a space above the liquid surface.

FIG. 4 shows schematically an alternative embodiment of the invention where the liquid is transported from one location to a number of locations.

FIG. 5 shows a schematic positioning of a device according to the invention at the centre of a circular biofilter unit.

FIGS. 6 and 7 show the placement of a device according to the invention in the centre of a biofilter.

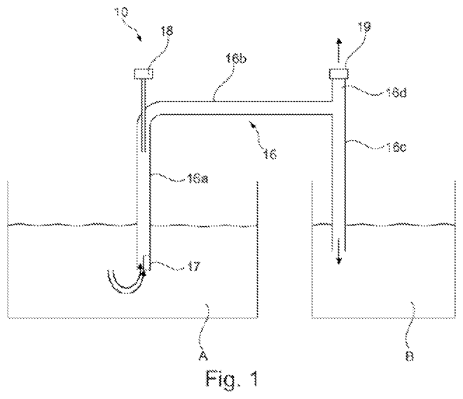

FIG. 1 shows the principle of transport and purification of liquid as the liquid is passed through pipelines 16 from one location to another location. The liquid can be moved from a first liquid volume A to a second liquid volume B as indicated in FIG. 1, but the liquid can also be moved from one point in the liquid volume A to another point in the liquid volume A, i.e. from a place in the liquid volume A to another location in the same vessel, preferably a net cage. Often, it is convenient to move fluid from a container's centre to a point closer to the container's periphery.

As shown in FIG. 1, at a first location, in a first volume of liquid A, one or more pipelines 16 are arranged to circulate water from a first liquid volume A to a second liquid volume B. There can, of course, be several such pipelines 16 for circulating water from a first to a second liquid volume B. The pipelines 16 have an upstream pipe part 16a which extends from a first location and, in the main, vertically upwards to above or at the surface level of the first liquid volume A. This upstream pipe part 16a is used for intake of liquid to the pipeline 16.

In a part higher up on pipeline 16a, preferably close to or above the liquid level in liquid volume A, an upstream pipe part 16a is in fluid communication with an, in the main, horizontal pipe part 16b. Preferably, this pipe part 16b is arranged to be slightly inclined, from pipe part 16a inclined downwards, or, in the main, horizontally. Downstream of the horizontal pipe part 16b, the liquid is further transported through a downstream pipe part 16c. This downstream pipe part 16c is provided with an, in the main, vertical pipe part. The liquid is passed through this pipe part 16c from the pipeline 16 to the second location, which in FIG. 1 is shown as the liquid volume B. The horizontal pipe part 16b can, in some preferred embodiments, have a considerable length so that the liquid is transported a considerable distance. In some preferred embodiments, the vertical pipe part 16d is relatively short, such that the liquid which is transported to the second location flows out near the liquid surface. In a part 16d, gases, foam and some liquid are removed from the main liquid stream. This part 16d is preferably provided for pipe part 16b or in the transition between pipe part 16 and pipe part 16c.

In a part of the upstream pipe part 16a, horizontal pipe part 16b, or pipe part 16d an injector 17 is arranged. The injector 17 supplies gas, gas microbubbles, preferably air, to the pipeline 16. The microbubbles which are transported through the pipeline 16 together with fluid from the first location will cause gases and smaller particles that are dissolved in the liquid to seek the microbubbles. For example, if CO₂ is dissolved in the liquid at the first location, this will be drawn towards the microbubbles and can be vented out of the liquid in tube part 16d. By the term “injector” is meant any supply of a gas into a liquid stream to form microbubbles of gas or air in the liquid. The term thus also covers an “ejector” which is based on the gas being passively sucked into the liquid jet (venturi) and an “injector” which is based on something being injected (is forced) into the liquid/gas stream.

An underpressure is established in the pipeline 16 in that means 19 to generate an underpressure are in communication with the pipeline 16. This can, for example, be a fan 19 as shown in FIG. 1. The underpressure in the pipeline 16 and injection of gases will cause liquid to flow effectively through the pipeline 16 from the first location to the second location.

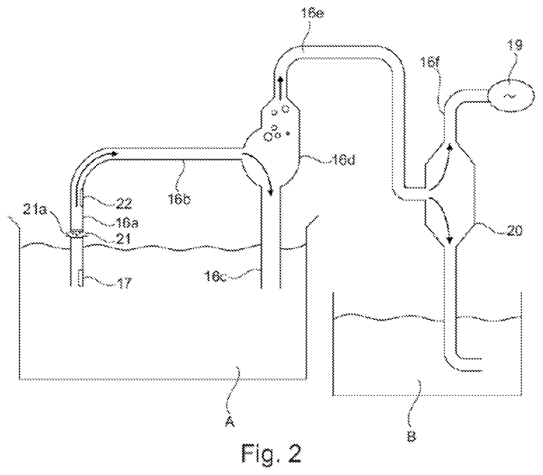

The liquid flow that runs through the horizontal pipe part 16b is then separated in that the pipe part 16b goes over to a downstream pipe part 16c where the majority of the liquid flows through and to a venting part 16e (shown in FIG. 2) where gases are drawn out of the pipeline 16 due to the established underpressure and the microbubbles supplied. By adjusting the underpressure in the pipeline 16, and adjusting the dimensions (diameter) of the downstream pipe part 16c and the venting part 16d, it is possible to also transfer a part of the fluid that flows through the horizontal pipe part 16b via the venting part 16e.

Tests have shown that it is possible to transfer up to 25% of the liquid via the venting part 16e. However, it is preferred that between 0.01 and 10% of the liquid is discharged via the venting part 16e and the remaining liquid is passed through the downstream pipe part 16c.

Supply of gases, preferably air, will ensure that the liquid which rises in the pipeline (in upstream pipe part 16a or horizontal pipe part 16b) becomes lighter and also that it is lighter than the liquid which is discharged from the pipeline via the pipe part 16c as gases/air are removed from the liquid in a venting part 16d. That the liquid in pipe part 16a is lighter than in pipe part 16c establishes flow and transport of the liquid through the pipeline 16. Experiments have shown that with sufficient supply of air via the injector 17 and establishment of a sufficient underpressure via the fan 19, the liquid is transported at a sufficient speed through the device 16 without the need to use pumps to pump the liquid, and one can, of course, increase the throughflow of the fluid in the pipeline 16 by the use of pumps.

There will also be the lighter part of the liquid (which has a large amount of dissolved gas bubbles) which is led out via the venting pipe part 16e.

In some embodiments of the device 10, in a part of the pipeline 16, i.e. in either the upstream pipe part 16a, horizontal pipe part 16b or downstream pipe part 16c, a pumping device 18 is preferably arranged to pump the water up from the first volume of liquid. Preferably this is a propeller pump 18 which is suitable for pumping large quantities with a low pressure. For example, as shown in FIG. 1, the pump is arranged in the upstream pipe part 16a such that liquid is drawn from the first volume of liquid via the upstream pipe part 16a.

In the solution which is shown in FIG. 1, the pipe part 16b has a considerable length, and it is slightly sloped downwards so that liquid that is pumped to the top of the pipe part 16b will flow through the pipe part 16b. A large liquid surface is generated, and this provides effective removal of any gases that are in the first liquid volume A. The liquid thus contains a lesser amount of dissolved gases after it has passed the pipe part 16b and venting part 16d.

If the device 10 is used in a fish farming installation, the first volume of liquid A is usually the water reservoir in which the marine organisms, such as fish, live, and this will eventually contain large amounts of dissolved CO₂. It is therefore an aim of the present invention to remove this CO₂ or at the same time replace it with oxygen or air. In the first liquid there is a relatively high content of CO₂ and low O₂. Furthermore, there will be a mixture of water and small air bubbles in the pipeline parts 16a and 16b, and CO₂ goes from being dissolved in water and into the air bubbles due to the equilibrium principle. In embodiments of the invention not shown in the figures, in downstream pipe part 16c there will be means for supplying oxygen to the liquid flowing out of the pipeline 16 via the downstream pipe part 16c.

As shown in FIG. 1, in a part, preferably in the transition between the horizontal pipe part 16b and the downstream pipe part 16c, a device 19 is arranged to establish an underpressure in the pipe part 16b. This is shown by a fan 19 in FIG. 1. Air bubbles which are in the liquid are almost drawn out of the liquid flowing through the horizontal pipe part 16b and further via the venting part 16d to the downstream pipe part 16c. Due to an underpressure and a large surface area between the air bubbles and water, this method will effectively remove CO₂ and other gases from the liquid.

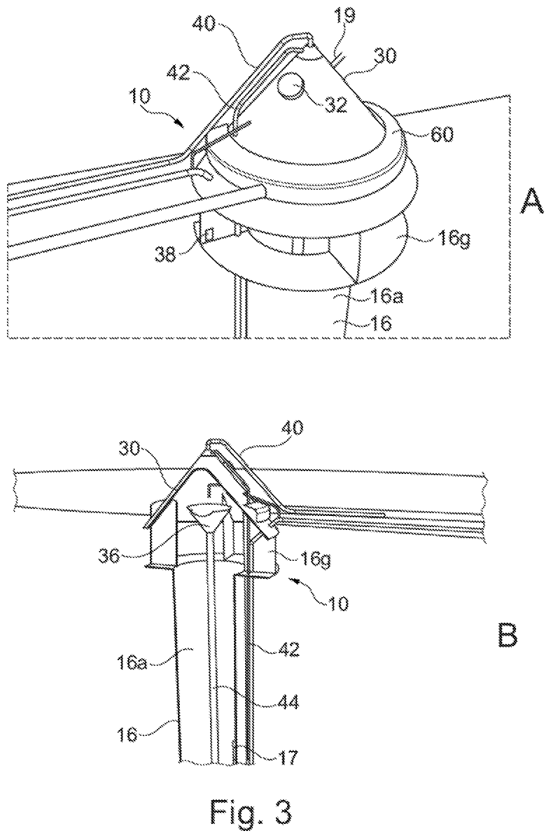

As shown in FIG. 1, the liquid in the first volume of liquid can be exchanged for gases as it is passed through the device 10, i.e., through the various pipe parts 16a, 16b and 16c. Along with this exchange of gases, the device 10 can be used to move liquid. As shown in FIG. 1, liquid is transported from a first location, shown as a first liquid volume A, via the pipeline 16 to a second location, shown as a liquid volume B. This can be from one net cage to another net cage or it can be from a segment of one net cage to another segment of the net cage. In some embodiments the liquid which is transported through the pipeline 16 is led back to the same liquid volume from which it is collected, i.e., that the first and the second liquid volume are the same net cage or net cage segment (as shown in FIG. 3).

In FIG. 2 an alternative solution is shown to illustrate the principle of the present invention, i.e., in addition to the solution in FIG. 1, a cyclone 20 is used to separate gases and liquid. It can be seen from FIG. 2 that the device comprises an, in the main, vertical upstream pipe part 16a which goes over into an, in the main, horizontal pipe part 16b. In the pipe part 16a means are provided for the supply of air, preferably microbubbles of air. It is not necessary, but in some embodiments means 18 (not shown in FIG. 2) in the upstream pipe part 16a are also used to draw water from a first location, shown as a first liquid volume A, and through the pipeline 16. In the transition between the horizontal pipe part 16b and the downstream pipe part 16c, a venting part 16d is established so that gases, when transporting liquid and air in via the upstream pipe part 16a and the horizontal pipe part 16b, in a venting part 16d, are removed from the liquid and discharged from the pipeline 16 via the venting pipe part 16e. From the venting part 16d, foam with particles and gases is extracted via the pipe part 16e, with means 19 being provided in the pipe part 16e or in conjunction with the pipe part 16e to establish an underpressure in the venting part 16d. The means 19 for establishing an underpressure can be directly connected to the pipe part 16e, and not necessarily via the cyclone 20 as shown in FIG. 2.

By establishing sufficient underpressure and appropriate dimensioning of the pipe peripheries for the pipe part 16e and the pipe part 16c, a part of the liquid will also be discharged out from the pipeline 16 via the venting pipe part 16e. It is the lightest part of the liquid, i.e., the part which has a high content of gas bubbles (microbubbles) and which has attached to particles in the water, which will be discharged through the venting pipe part 16e. The heaviest part of the liquid will be discharged from the downstream pipe part 16c.

It is an advantage that the venting part 16d is of a certain volume, and in particular that the liquid surface is of a certain size. Then, one gets a large interfacial fluid: gas are which, together with the underpressure which is established, will provide effective extraction of gases dissolved in the liquid. The air bubbles which are supplied to the liquid from the injector 17 via the upstream pipe part 16a or the horizontal pipe part 16b will lead to the smaller particles also being drawn out of the liquid and into the gas phase, and out of the venting pipe part 16e. Foam will also form in this part which is pulled over into the pipe part 16e. The conditions which are established in the venting part 16d, i.e., underpressure, large surface, and liquid with air bubbles will effectively separate gases from the liquid. The gases are removed via the pipe part 16e, and the largest part of the liquid is discharged via the downstream pipe part 16c.

Furthermore, in the device 10 which is shown in FIG. 2, a garland 21 with openings 21a is arranged for the passive suction of air. This garland 21 can be arranged in the upstream pipe part 16a above the liquid surface in the liquid volume A, or it can be arranged in the horizontal pipe part 16b. The openings 21a can be adjustable so that one can control the amount of air supplied.

Furthermore, in the device 10 which is shown in FIG. 2, there is an injection device 22 which can supply (inject) liquid to the liquid flow in the pipeline 16. The injection device 22 is preferably arranged in the upstream pipe part 16a but can also be arranged in the horizontal pipe part 16b.

Furthermore, in the device 10 which is shown in FIG. 2, a cyclone 20 is arranged for separating liquid and gases which flow through the cyclone from the venting pipeline 16e. The means 19 for establishing an underpressure can then be in communication, via the cyclone venting pipeline 16f, with the cyclone 20.

FIG. 2 shows that the first and second volumes of liquid are different, i.e., the liquid is transported through the device 10 to exchange gases and to remove foam and particles in the liquid, while the bulk of the liquid is conducted via the downstream pipeline 16c from the liquid volume A to the liquid volume B.

FIG. 3 shows an embodiment of the invention which is well suited for the transport of water from a lower part to near the surface, i.e., from one location to another location. The device 10 comprises an upstream pipe part 16b for receiving liquid from a certain depth. The device 10 in FIG. 3 is particularly well suited for use in a fish farming net cage where lice skirts are used because it can transport fluid from the depths of the net cage (below the lower edge of the lice skirt) to an upper part of the net cage, preferably to the surface of the net cage. In this way, pure water with good oxygen content can be transported to the surface.

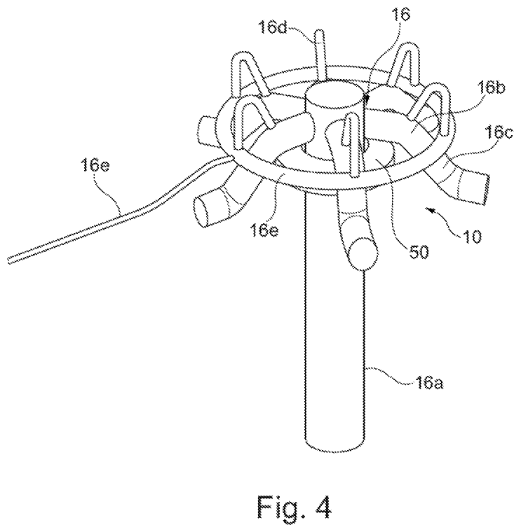

Liquid is introduced into the pipeline 16 at the bottom of the pipeline part 16a, and the supply of microbubbles via means 17 causes the liquid to flow upwardly into the pipeline and flows out from the pipeline 16 via the outflow pipe part 16g. In the embodiment shown, the outflow pipe part 16g extends in the whole circumference of the pipe part 16a of the centre pipe's pipe section, i.e., in a 360 degree sector, so that the liquid is evenly distributed in the net cage in all directions from the centre toward the periphery. The outflow pipe part 16g can also be formed as a series of separate outflow pipelines 16b/16c, and these can also be of a certain length so that the liquid is taken some distance out from the centre of the net cage. Such a solution with several pipe parts 16b/16c is shown in FIG. 4 and explained in more detail below.

In addition to the transport of fluid from one location to another location, the device 10 shown in FIG. 3 is also well suited for the supply of oxygen to the water. Often, the water in a cage contains too little oxygen after a time, and it is then appropriate to supply oxygen and/or air to the water at the same time as it is transported from the deep to the surface. Low oxygen levels in water layers can also occur in some locations where farming is operated. It can then be appropriate to add oxygen to the water.

The device 10 which is shown in FIG. 3 is therefore equipped, in an upper part of the pipeline 16, with a dome 30. The device 10 is arranged in the water so that the outstream pipe parts 16g are preferably below the liquid surface, while an upper part of the dome 30, which preferably has the shape of a funnel, is above the liquid surface, as schematically illustrated in FIG. 3.

Oxygen and/or air is supplied to the inside of the dome 30, i.e., in the pocket enclosed by the dome 30 over the liquid surface, via pipelines 40 and damper 32. The amount of oxygen supply or air can be regulated based on the oxygen content of the water, which can be measured by a sensor 38. Supplied oxygen, and optionally air, and the gas in the microbubbles will be exchanged at the interface between liquid and gas in the dome 30.

It is preferred that a part of the O₂ and/or air which is supplied to the dome 30 is led further to the injector 17 for the generation of microbubbles. It is further preferred that the means for the supply of microbubbles is an ejector 17 which is driven by supplied liquid, preferably water under pressure. It has been found that water at 3 bar gives a good production of microwaves as the ejector 17 sucks in oxygen or air via the pipeline 42. The supply of oxygen/air to the ejector 17 can also take place via a separate supply line (not shown in FIG. 3) which does not come from the dome 30. Also preferably provided to the dome 30 are one or more check valves 34.

It is preferred that the supply of the microbubbles is arranged so that they are spread over the entire cross-section of the upstream pipe part 16a. For example, the means 17 can be angled in different directions, or they can be arranged in several places in the cross-section of the pipe part 16a.

When one applies microbubbles to liquid, foam and dirty water will accumulate at the liquid surface. It is an advantage that this is removed before the water is transported out of the pipeline 16 and back to the net cage, and therefore in the embodiment which is shown in FIG. 3, a funnel-shaped unit 36 is arranged to collect this foam and dirty water. Foam and dirty water are then discharged via the pipeline 44.

In some cases, it is necessary that this purification of foam and particles from the liquid is effective, and in some cases it can also be necessary to lift the water which is transported in pipeline 16 some distance above the liquid surface, for example, if this liquid shall be transported over the float collar to a net cage. It will then be necessary to establish a reduced pressure in the dome 30 and means 19 can therefore be provided to the dome 30 to establish such reduced pressure.

Establishment of a vacuum or an underpressure in the pipeline 16 or a part thereof, and the effect this has on the separation of foam and particles from the liquid are explained in connection with FIGS. 1 and 2, and the same principle is used in that in the solution in FIG. 3 an underpressure is established in the dome 30. Alternatively, as shown in FIG. 2, the dome 30 can be connected to a cyclone 20.

In order to establish an improved separation of foam and particles from the liquid, the outflow pipe part 16g is comprised of, in some embodiments of the invention, an, in the main, horizontal pipe part 16b, a downstream pipe part 16c for passing fluid out of the pipeline 16, and a venting pipe part 16d for passing gases, particles, and a part of liquid out of the pipeline 16 via the pipe part 16e. Such a solution is explained in more detail with reference to the embodiment in FIG. 3.

In particular, we will mention that an embodiment of the invention can combine features and elements of respective FIGS. 3 and 4.

FIG. 4 shows an alternative embodiment of the present invention, i.e., where the horizontal pipe part 16b is provided with several parts for the extraction of gases (and smaller parts of liquid) from the pipe part 16b.

In the embodiment which is shown in FIG. 4, the device 10 is provided with a cyclone 20 for separating gases and liquid which are led out from the venting pipe part 16e, but the device will also function without such a cyclone 20. In some embodiments more than one cyclone is used. Means 19 is the central fan or vacuum pump which constantly maintains an underpressure in the pipeline 16 and generates extraction of gas, and a part of liquid, from the pipe parts 16e, optionally via the pipe part 16f from the cyclone 20.

The liquid is transported via the intake pipe part 16a and through the pipe part 16 to an outlet via the pipe part 16c. One or more injectors/ejectors 17 are provided in the pipeline 16, preferably in the lower part of the pipeline part 16 and in the pipeline part 16b. It is preferred that a pump which supplies liquid, preferably water, to the injector/ejectors 17 is connected to the injectors/ejectors 17.

Furthermore, it is also the preferred that the injectors/ejectors 17 are connected to an open-air hose for the supply of air into the ejectors 17. This takes place by venturi when water flows through the nozzles.

Solutions that are in accordance with the general principles shown in FIGS. 1 and 2 are patent applications with the same owner as the present application. However, these patent applications are not widely available at the time of application for the present application.

FIG. 4 shows a solution according to the present invention. Liquid is passed from a first location to a second location via the pipeline 16. The pipeline 16 has an inlet for liquid via an upwardly rising pipe part 16a. This pipe part then passes into a pipe part 16b, and further through an end part 16d to the outlet part 16c.

In the solution which is shown in FIG. 4, the vertical extent of the pipe part 16c (which carries the liquid out to the second location) is relatively small, so that the liquid discharges just below or at the liquid surface. The solution which is shown in FIG. 4 is intended to be used in fish farming net cages to transfer water from a depth in the net cage to a position near the surface of the net cage. Therefore, the vertical pipe part 16c is not mainly vertical, but can run downwards at a tilt, and is also preferably moved to a more horizontal pipe part 16g so that liquid is conveyed more horizontally out of the pipeline 16. As for the solution in FIGS. 1 and 2, the pipe part 16b is of a certain length to establish a significant fluid: air interface.

However, this pipe part 16b need not be so long if the solution is to be used essentially for the transport of liquid, i.e., where it is not so crucial that liquid be vented and cleaned for smaller particles. Thus, the length of 16b can be varied according to purpose. Furthermore, the horizontal extent of the pipe parts 16c and 16g can be varied according to how far out in the periphery one wishes to move fluid. The solution which is shown in FIG. 4 is comprised of several pipe parts 16b, 16d, 16c, and it has been found that it is advantageous to bring these separate pipe parts 16b, 16d, 16c together into a common venting pipe 16e. In FIG. 4, six pipe parts 16b, 16d, 16c are shown, all of which extend outwardly from the vertical pipe part 16a. These can have different lengths so that they spread the water over the widest possible area. These pipe parts 16b, 16d, 16c are then connected to a venting pipe 16e which runs as a ring outside the pipe part 16a. Thus, means 19, such as a fan 19, for providing underpressure in the pipeline 16 are arranged in communication with one or more places on the venting pipeline 16e. The venting pipeline 16e can further be in fluid communication with a cyclone 20, with the venting 16f as shown in FIG. 2.

The pipe parts 16b can run from the pipe parts 16a in the same vertical region, or they can run from different vertical positions in the pipe parts 16a.

Further, in the pipe part 16b, in the longitudinal extent of the pipe part 16b, several venting parts 16d can be provided so as to achieve multiple purification of the liquid which is passed through the pipeline 16.

By using the device 10, large amounts of liquid can be moved from the depths of a net cage to the water surface. This is very beneficial if the net cage uses lice skirts, as the large amount of water which is brought to the surface will provide an increased downward flow of water which will reduce the possibility of lice entering the net cage.

Of course, an installation can have one or more such centrally arranged upstream pipe parts 16a. The branches that are established, i.e., the combination of pipe parts 16b, 16d and 16c, can be short or extend further out into the periphery, and all the way to the net cage edge. In some designs, the branches extend beyond the net cage. Also, the height of the branches, i.e., the horizontal arms, can vary. They can also be supported by their own buoyancy bodies/rafts.

A preferred embodiment of device 10 is comprised of float and buoyancy elements 30 sufficient for the device 10 to float in the water surface. These float and buoyancy elements are preferably arranged enclosing the vertical upstream pipe part 16a.

Alternatively, the device 10 can be kept afloat in a net cage 10 by being anchored to the net cage float collar.

The principles of the invention were tested according to the embodiment as shown in FIG. 3. A pipe with a diameter of 300 mm ID was used as the main pipe. The ejectors were installed at 4 m water depth. This gives a driving height of 4 metres and the GF DN25 ejectors were chosen with ejector size 5 mm. At a pressure of about 4 bar, about 1800 litres of water per hour will be pumped. This will provide a supply of air at 4 m of about 4000 l/h.

It was intended to flow about 5000 l/min. When we got into the facility this was a good match. Flow measurement in the pipe showed about 1.2 m/s which gives about 5000 l/min. A foam formation was observed under the hat. The foam was flushed into the funnel and water and foam were transported to the desired depth. In this test, the O₂ was measured and it was found that the O 2 level rose from 83% to 95% in the outlet. In this test no O₂ was supplied in the hat.

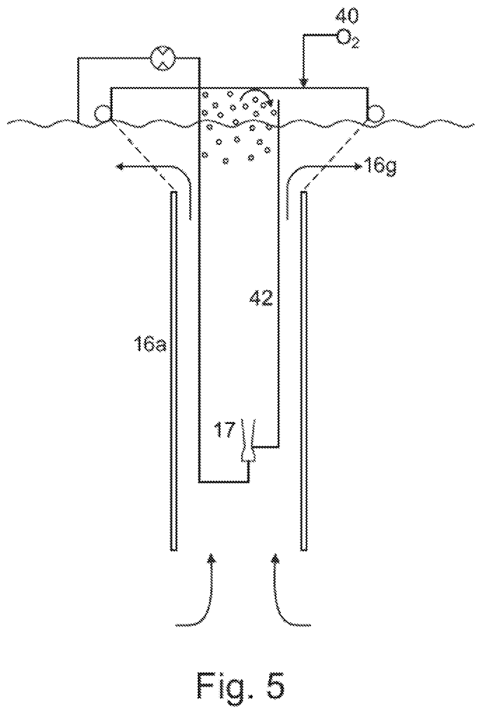

FIG. 5 shows an embodiment of the invention where it is placed floating in the sea. A pipe 16a is balanced vertically in the water by buoyancy up and ballast down. This pipe is suspended and positioned under a floating dome 30 with a flexible liner such that it is constantly under the dome. Ejectors 17 lift the water in the pipe in that a gas that is under the dome is sucked down and pulled into the water stream in the ejectors 17 which are created from the pump such that microbubbles are formed.

The microbubbles create lift in the water while providing a good gas exchange with the water. Under the dome 30, ordinary air or oxygen can be added. This causes the normally low oxygen water down at the bottom to be lifted and oxygenated on the way up through the pipe. The excess oxygen is collected under the dome and subtracted again, such that oxygen is not lost.

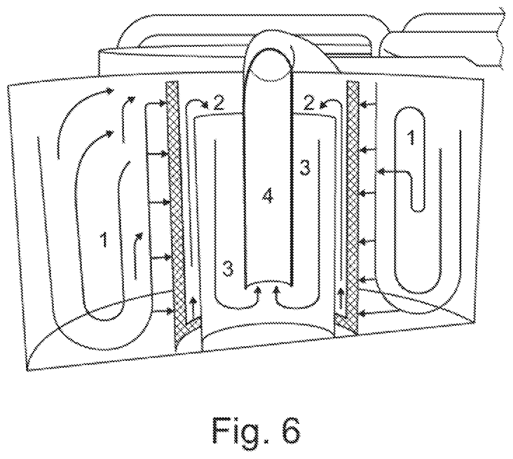

FIG. 6 shows the flow of water in an embodiment where the device 10 is placed in the bottom of a vessel and where there is no dome 30. Air will then be drawn down to the ejectors which provide lift in the water such that it flows up to 2.

Correspondingly, ejectors or a pump in 4 will generate lift on the water and transfer it to another location. This device without the dome 30 can be used where no additional oxygenation is needed beyond that achieved by using ordinary air.

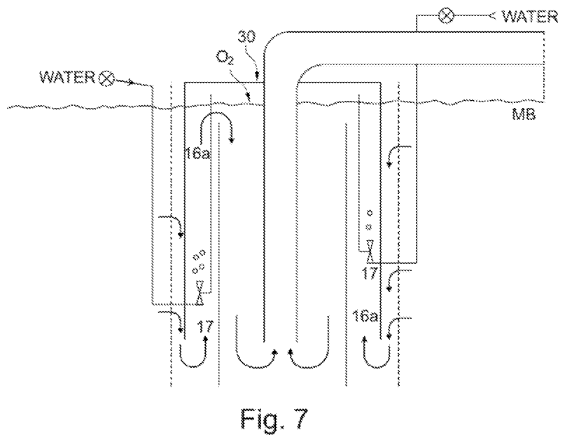

FIG. 7 shows the same device with a dome 30 to capture oxygen in cases where additional oxygenation of the water is desired.

The devices in FIGS. 6 and 7 can be located in a fishing vessel or a biofilter. A strainer is shown to prevent fish or bio-bodies from entering the device. Ejectors drive the water as shown by arrows by lifting it up to 2 such that it flows down to 3 and up and out into the centre pipe 4. By oxygenation under the hat and with a supply from this cavity and down to the ejectors, a good oxygenation of the water will be obtained while excess oxygen is collected and reinjected into the ejectors. In this way, the economy of the oxygenation becomes good.

1.-31. (Canceled)

32. A device (10) for transport of liquid from a first location to a second location, the device (10) comprising:
a first pipeline (16) for transport of the liquid from a first location to a second location, the first pipeline (16) comprising:
a first upstream pipe part (16a) for intake of liquid from said first location; and
one or more outflow parts (16g) arranged in an upper part of the pipeline (16) for passing the liquid out of the first pipeline (16); and
means (17) arranged in the upstream pipe part (16a) and provided for the supply of microbubbles to the pipe part (16a);
wherein the length of the upstream pipe part (16a) and position of the outflow pipe part (16g) are arranged so that the liquid is taken up in the first pipeline (16) from a first location at a given depth in a liquid volume, and that the liquid discharges from the outflow pipe part (16g) at a second location which is vertically higher in liquid volume than the first location.

33. The device (10) according to claim 32, wherein the upper part of the first pipeline (16) is in the form of a dome (30) which establishes a space above the liquid surface.

34. The device (10) according to claim 33, wherein the dome (30) is arranged such that the upper part of the dome (30) is above the liquid surface, while the lower part of the dome (30) and the outflow pipe part (16g) are below the liquid surface.

35. The device (10) according to claim 32, wherein the means (17) for the supply of microbubbles is an ejector (17) which is driven by a supply of the liquid.

36. The device (10) according to claim 32, wherein a gas or air can be supplied in an upper part of the dome (30).

37. The device (10) according to claim 36, wherein the gas is oxygen (O₂) which is supplied via a second pipeline (40).

38. The device (10) according to claim 32, wherein oxygen (O₂) is supplied to the ejector (17) and that parts of said O₂ are retrieved via a third pipeline (42) from the inside under the top of the dome (30).

39. The device (10) according to claim 35, wherein air can be supplied via a damper (32) in the dome (30).

40. The device (10) according to claim 32, wherein the dome (30) is provided with one or more check valves (34).

41. The device (10) according to claim 32, wherein the outflow pipe part (16g) extends in parts of, or in a 360-degree sector, from the upstream pipe part (16a),

42. The device (10) according to claim 32, wherein the means (17) for the supply of microbubbles is angled in different directions and arranged so that the microbubbles are spread over the entire cross-section of the upstream pipe part (16a).

43. The device (10) according to claim 33, wherein a funnel-shaped unit (36) is arranged near the liquid surface of the dome (30) set up to be able to collect foam in the liquid surface and drain this foam via a fourth pipeline

44. The device (10) according to claim 33, wherein the dome (30) is closed and means (19) are provided to the dome (30) to reduce the pressure in the dome (30).

45. The device (10) according to claim 32, wherein the device (10) is comprised of a sensor (38) for measuring the oxygen content of the water which flows out of the outflow pipe part (16g).

46. The device (10) according to claim 45, wherein the supply of air and oxygen is regulated by the oxygen level in the water measured by the sensor (38).

47. The device (10) according to claim 32, wherein a cyclone (20) is connected to the dome (30) or a pipe part (16d).

48. The device (10) according to claim 32, wherein the device (10) is comprised of floating or buoyancy means (30).

49. The device according to claim 48, wherein the floating or buoyancy means (30) is a floating collar with a fixed buoyancy and a number of vertical air-filled pipes where water can be injected to fine-tune the depth.
